(19) United States
(12) Patent Application Publication
(10) Pub. No.: US 2007/0277686 A1
(43) Pub. Date: Dec. 6, 2007

(54) Method for Four-color Printing and Dyeing

(75) Inventors: Cyrus Shahrzad, Emerson, NJ (US); Clinton Wu, Marina Del Rey, CA (US)

Correspondence Address: Yungping Chiang, 12462 Oliver Cromwell Dr., Herndon, VA, 20171, US

(73) Assignee: CSC MERCHANDISE, LLC, Marina Del Rey, CA (US)

(21) Appl. No.: 11/757,357

(22) Filed: Jun. 2, 2007

(30) Foreign Application Priority Data
Jun. 6, 2006 (CN) 200610087307.5

(51) Int. Cl. B41M 1/12

(52) U.S. Cl. 101/129

(57) ABSTRACT

The invention is involved in a method for four-color printing and dyeing in textiles industry. The process comprises the processes of engraving and printing & dyeing. The process of engraving includes separating the color picture into four primary colors (Cyan, Magenta, Yellow and Black). Four data files are generated in accordance with the result of color separation, and stored in four compact discs representing separated colors, respectively. Special curves are created based on types of fabric and types of design in this process. Four screens are made for the separated four colors in accordance with the data files. Then the exact positioning and superposition of the locating points or cross marks of the four screens are ensured during the process of printing and dyeing. The present invention provides a fastest and cost-efficient process for printing and dyeing in textile industry.

### TECHNICAL FIELD OF THE INVENTION

The present invention relates to a method for four-color printing and dyeing in the field of “Textiles and Towels” printing.

### BACKGROUND OF THE INVENTION

A Chinese patent application, “A method for graphic printing and dyeing for towel products” (CN01138932.X), disclosed a printing process for textile materials, which resolved a problem of blurred graphics during printing. This process includes three steps: 1). A synthetic fiber layer is weaved on the cotton towel; 2). Graphics, drawn by computer program, are printed on printing papers with heat-treating printing color ink, and the printing papers with graphics are cut out; 3). The cut papers with graphics are placed on the synthetic fiber layer of cotton towel, and printing and dyeing are proceeded by a transmission temperature-control duplicator. To print graphics and text onto the synthetic fiber layer of towel products of high water-absorbing capacity, the full water-absorbing capacity of towel products can generally be maintained, while the heat treatment technique can be utilized to print various graphics and texts on the synthetic fiber layer of weakened water absorbing capacity.

“A method of plate-making for dichromatic textile printing” (CN93106590.9), another Chinese patent application, disclosed a method including the original pattern selection, photo color separation and screening: 1) the suitable original pattern, such as color photo, slide, watercolor painting, elaborate-style painting or oil painting, for plate-making, is selected; 2) photo color separation consists of: (A) various masking films are prepared to maintain the contrast of various colors, and, the highlight mask, additive color mask, subtractive color mask and gradation mask are prepared in accordance with contents of the original pattern; (B) color separation of the original pattern: add color filter to the plate-making camera to obtain negative films with four primitive colors as yellow, fuchsia, blue and black from the original pattern; (C) correct the negative film: after color separation, manually correct the color of negative films to satisfy requirements for plate making, allowing natural and pure colors; 3) screening: This word SCREEN is different from the one we use to print with. In the old days when the separations of colors was made by hand, they used a film with very small dots as negative matrix to make gray tones of each color into very small solid dots. The reason was that the paper print machines did not understand the gray areas. For a machine no matter how sophisticated, it is Yes or No and gray tons of any tone is not yes or no it is Maybe! Select screens with screen angle being related to the screen angle of the proposed flat screen and rotary screen; select 1-4 angles for the flat screen and 1-2 angles for the rotary screen, and then place the screen on the sensitive film, followed by color-separation film and masking film; upon exposure, developing and fixing, we can have the screened separation film; after retouching and copying for twice, we can have the dye printing negative with fixed screen dots; after fixing it to the flat screen or rotary screen for dye printing and printing down the halftone screen for dye printing, we can start dye printing then.

The patent with the application number of CN89106224.6 also has disclosed a method for making silk screens capable of printing patterns with dark-and-light color gradation. By making a corresponding pattern composed of steeples arranged and distributed color dots (with sparse dots for light areas and dense dots for dark areas) in accordance with the dark-and-light color-gradation transformation characteristics of the proposed mono-color reference pattern, we can make this color-dot pattern into a silk screen with the similar pattern, which can then be used to print mono-color patterns with dark-and-light color-gradation. However, the aforesaid methods are unable to realize high-precision and photo-like precision printing and dyeing.

### SUMMARY OF THE INVENTION

The present invention has provided a novel method for four-color printing and dyeing for the textiles. The method includes the process of engraving and printing & dyeing. The engraving process of the present invention consists of the following steps:

i) color picture is separated into four primary colors: Cyan, Magenta, Yellow and Black;

ii) four data files are generated in accordance with the result of color separation and stored in compact discs (CDs), special curves are created based on types of fabric and types of design in this step;

iii) four screens are made with very fine mesh for the four colors in accordance with the data files.

The process of printing and dyeing consists of the following steps: print out different color gradations on each screen in line with the picture, and ensure exact positioning and superposition of the locating points or cross marks of the four screens during the process of printing and dyeing.

### DETAILED DESCRIPTION OF THE PREFERRED EMBODIMENTS

In order to complement the existing technologies, the present invention has provided a novel method for four-color printing and dyeing especially formed for the textiles, including the process of engraving and printing & dyeing.

The Engraving process (or the Making of the means of printing either by Rotary screens or by Flat screens) of the present invention consists of the following steps:

i) Color picture or the multi colored Design is separated into four primary colors: Cyan, Magenta, Yellow and Black.

ii) Four data files are generated in accordance with the result of color separation and stored each on one compact disc (CD).

iii) Four screens are made with very fine mesh of number no less than 160 XX for said four colors in accordance with said data files.

The process for preparation for printing of each screen is described as following: Co-ordinate setting of each screen. To set-up the locating points (or cross marks) on the corresponding screen as to the fact that the screens representing the dark colors, based on the way the original photo looked are considered. The rules will change. Contrary to the established rules of paper printing that the order of CMYK (Cyan, Magenta, Yellow and Black) has to be followed, we start with the darkest color to be the first to print and the lightest (or the color that is the least obvious) to be the last to print in textiles.

The process of printing and dyeing consist of the following steps: print out different color gradations on each screen in line with the picture, and ensure exact positioning and superposition of the locating points or cross marks of said four screens during the process of printing and dyeing, while the traditional order (CMYK) for four-color printing and dyeing is no longer to be followed.

Benefit of this invention: The mesh number of the selected silk screen shall be no less than 160 XX which is critical part of this invention.

Although having the best-separated design and the best looking screens with any higher mesh number, you can only print a few yards of the fabric because screens get clogged. The pigments that form the colors we print with on the fabric are very small. but no matter how small, they have to pass freely through the openings of the screen. If the opening of the screen is smaller than a certain size, we will end up clogging and closing of the small openings and screen dries up. We have made many tests and tryouts to reach to this size mesh.

The process of four-color printing and dyeing of the present invention can easily have the effect of ordinary spot-color printing, which if was to be used would require well over 18 or even more screens to duplicate a photo look and even at that the printed piece will never come close to a four color process printing. Because a normal flat screen that represent one shade of one color, cannot do the job of a screen that represents thousands of shades of one color.

### EXAMPLES

The process of engraving: the selected design or photo is: Scanning the design or photo into the computer with a computer scanner, the colors of said design or said photo are separated into four primary colors (Magenta (red), Yellow, Cyan (blue) and Black) based on visual color sensitivity. The primary colors are described CMYK (Cyan, Magenta, Yellow and Black) in the printing industry. Then each of said four separated color is generated as a single data file, which is stored each on one compact disc (CD). In this stage we apply the program of separating the curves of paper printing into the curves of textiles. We have developed special curves based on each fabric and also based on the types of fabric and type of design.

The curves are the means of controlling the amount of density that each one of the four primaries (CMYK) will have before they reach the CD. The basic set up rule established by the digital and paper-printing industries has been the full strength of the colors to get as close to a photo look as possible for the paper. This rule is no longer applicable to the textiles by present invention. However, as a matter of fact, the textiles have different requirement for curves. The more absorbent fabrics, the less amount of color is required. The lightest weight of fabric, such as silks, gains the lightest, while the thickest fabric gains the deepest. The curves we generated have been applied and proven to work. Both fabrics and original art to be reproduced determine the shape of curves.

In making of the screens, durable Nylon treads should be used. The best so far has been proven to be the Nylon since it does not stretch when pulled. The mesh number of silk of the screen has to be no less than 160 XX per square inch. The four CDs containing the information of four separated colors will be put into a screen maker, which can read the information contained on the CDs and transform this information into the controlled dots on the screen maker. There are two preferred systems, but not limited to these two mentioned here. The screen makers: Wax Jet Printers, and Laser system.

A) For the flat screens, Wax Jet Printer can be used. This system requires the screen being engraved to be coated with light sensitive emulsion. The light sensitive emulsion is a certain type of adhesive that has as important part of it a chemical that hardens with exposure to the intense light. It is in form of high viscosity liquid (as in honey), which is applied on to the surface of the screen in the dark room. After drying the coating will be sensitive to light. The areas that get exposed with light will become solid and nothing can wash the emulsion off. The unexposed area which have been washed away would allow the paint pass through the screen. Wax Jet system can transform information on the CDs into very small size dots, which are made of hot black wax. Wax Jet Printer, spits the small dots on the coated screen by following the data on CDs. Two Wax Jet printers have been tested. One system is manufactured by Hangzhou Kaiyuan Computer Technology Co. Ltd in the Peoples Republic of China and, another similar system is made by Leucher Ink-jet System of the Switzerland.

The Wax Jet Printing head squirts wax droplets onto the surface of coated screen. The screen then is exposed to a very high and intense light source for few minutes. The small black wax droplets perform as light blocking agents; leaving the areas they sat unexposed to the light. Screen then is washed with luck warm water (from forty to sixty degrees centigrade). This washing performs a vital job of opening the areas where the black wax is dropped. Tiny openings, which allow the desired colors to go through and onto the surface of the textiles, are formed in the screen when the waxes are washed off.

B) For the rotary screen, Laser system can be used. This system being made for the rotary screen making, actually exposes the coated screen with the laser light that makes the light sensitive emulsion hardened. This system does exactly the reverse of Wax Jet printers instead of the wax it exposes the screen with the design translated into small sharp laser lights. The tiny spotlights actually work on reverse; the light actually hardens and closes the areas we don't want to stay open.

Printing and dyeing can be initialed once the four screens have been made.

The process of printing and dyeing:

The printer at the textile print machines ensures exact positioning and superposition of the locating points or cross marks of the aforesaid four screens. It is the most critical to coordinate setting of screens, to set locating points or cross marks on the corresponding screens. The dense colored screen with dark colors is the first to be printed. The screen with the least coverage is to be the last or second to the last to be printing. These curves and the methods of selecting which color to be printed FIRST, called as pitching in the textile printing industry, is one of the essence factors in this invention, which is against the established traditional printing orders of CMYK in printing industry.

In general, printing industry on paper or any other flat medium has strictly followed the order of CMYK. The present invention ignores the traditional order of CMYK, and the order does not have to be followed in the printing and dyeing for textiles with the present invention. The printing order of colors, is determined by design and fabric. The design includes photo, oil paintings, watercolors or any surface that carries multi-mum of mixed colors. A specific set of curves are made based on specific design and fabric, which makes sure the print-outs on fabrics are as close to the original design as possible.

Considering the fact that we are at the age of digital printing and naturally and in comparison, printing with the digital printers cannot be compared with any other type of printing this far and before our present invention. What brings our invention to market is speed and cost, in comparison to the digital and computer printing technology.

A) Speed: The Fastest digital printers today are able to print close to 360 square feet per hour. Another word on a six feet wide fabric, the digital printer produces twenty yards of textile. Our system will produce one thousand five hundred yards of digital printed textiles in the same amount of time.
B) The cost: Today an average cost per square feet is about ten dollars (more or less based on the amount of order) our system will cost less than a dime per square feet.

What is claimed is:

1. A technical process for four-color printing and dyeing, said process comprising: i) Engraving: which includes separating color picture into four primary colors (Cyan, Magenta, Yellow and Black); Generating four data files stored in each compact discs (CD) for each color file in accordance with the result of color separation, said data file including specific curves being created by applying program for separating curves of paper printing based on types of fabric and types of design; and making four screens for said separated four colors in accordance with said data files; ii) Printing and dyeing which require exact positioning and superposition of the locating points or cross marks of said four screens.

2. Said process according to claim 1, printing order of CMYK (Cyan, Magenta, Yellow and Black) can be broken, dense colored screens with dark colors are first to be printed, least coverage are to be the last or second to the last to be printing the design on the textiles.

3. Said process according to claim 1, said screen is preferred made of durable Nylon treads, or similar man-made fiber that can perform under stress of the screen printing.

4. Said process according to claim 1, said compact discs can store data files and can be put into screen maker, which can read information contained on said compact discs and transform said information into controlled dots onto said screens.

5. Said process according to claim 1, said design includes photo, oil paintings, watercolors or any surface that carries multi-mum of mixed colors.

6. Said process according to claim 1, said screen maker is a Wax Jet printer whose head squirts wax droplets onto surface of said screen coated with light sensitive emulsion that is exposed to a very high and intense light source, said coated screen then is washed with warm water to generate very small openings which allow passage of related colors to go through and onto surface of textiles.

7. Said process according to claim 1, said screen maker is Laser printer being made for rotary screen making, the coated screen with light sensitive emulsion is exposed with the laser light.

8. Said process according to claim 4, said screen maker is a Wax Jet printer whose head squirts wax droplets onto surface of said screen coated with light sensitive emulsion that is exposed to a very high and intense light source, said coated screen then is washed with warm water to generate very small openings which allow passage of related colors to go through and onto surface of textiles.

9. Said process according to claim 4, said screen maker is Laser printer being made for rotary screen making, the coated screen with light sensitive emulsion is exposed with the laser light.

10. Said process according to claim 8, said small openings in said screen have no less than 160 XX, preferred from 250 to 360 XX.
